(19) United States
(12) Patent Application Publication
(10) Pub. No.: US 2001/0032152 A1
(43) Pub. Date: Oct. 18, 2001

(54) Temporary internet mobile showroom providing E-commerce capability

(76) Inventors: Rajesh Khosla, Orange Village, OH (US); Stuart R. Fishman, Chagrin Falls, OH (US)

Correspondence Address: Eric D. Jorgenson, ARTER & HADDEN LLP, Suite 1100, 925 Euclid Avenue, Cleveland, OH, 44114, US

(21) Appl. No.: 09/750,477

(22) Filed: Dec. 28, 2000

Related U.S. Application Data
(60) Provisional application No. 60/173,379, filed on Dec. 28, 1999.

(51) Int. Cl. G06F 17/60

(52) U.S. Cl. 705/27

(57) ABSTRACT

A mobile showroom system having Internet access for e-commerce transactions. The system comprises one or more articles of commerce provided for physical presentation to a customer in a first showroom. The system also comprises a customer system which is operably positioned in the first showroom for providing information to the customer about the one or more articles of commerce, and for facilitating an e-commerce transaction for the purchase of select ones of the one or more articles of commerce. The customer operates the customer system to obtain information about the select ones of the one or more articles of commerce. The customer also performs the e-commerce transaction utilizing the customer system. The one or more articles of commerce and the customer system are then relocated to a second showroom in response to predetermined criteria.

This application claims priority under 35 U.S.C. §120 to U. S. Provisional application Ser. No. 60/173,379 entitled “Mobile Showroom” filed on Dec. 28, 1999.

### BACKGROUND OF THE INVENTION

1. Technical Field of the Invention

This invention is related to mobile showrooms, and more particularly to a showroom system having a minimum stock of merchandise, and which can be relocated and configured to provide potential customers with physical inspection of the merchandise, and Internet access for e-commerce purchase of the merchandise.

2. Background of the Art

Conventional “brick-and-mortar” (B&M) retail establishments spend enormous amounts of money in order to entice a potential customer to purchase its products and/or services. Advertising, maintaining a ready supply of products in stock for the instant transfer of the product to a paying customer, and providing personnel to assist in finding the product, answer any questions of the customer, and to complete the purchase transaction, are just a few of the conveniences provided by the B&M retailer to induce a customer to make a purchase. However, all of these conveniences factor into the bottomline cost of the product or service. Labor costs for the on-site personnel and capital costs which include the need to maintain an inventory work to increase the ultimate price of the merchandise the customers purchases. Additionally, conventional B&M retail businesses are locked into a particular geographic location for an extended period of time due to building costs for providing the shopping environment and housing inventory, and when leasing space, often fail for reasons due to long-term leases in an unprofitable venue. The conventional retail establishment can not simply pack up and go to the greatest source of potential customers, but relies on its various inducements to bring the customer into the store.

With the advent of the Internet in recent years, on-line retailing (or “e-commerce”) has become increasingly popular. E-commerce provides its own list of benefits to the consumer, including eliminating the inconvenience of having to travel to the retail store to search out a product or service, offering a potentially larger selection of products and services, ease of making the purchase, delivery to the desired location by simply entering the shipping information during the on-line purchase transaction, and in many cases, no taxes are charged. Consequently, the on-line retailer sidesteps many of the costs associated with conventional B&M retail operations. These cost savings are then passed on to the on-line customer in the form of lower prices.

However, web-based business are not without problems of their own. Many web-based businesses operate at a small profit margin as simply “pass-through” entities which provide an intermediary function between vendors and consumers. Additionally, it is difficult for a web-based business to “be heard” as conventional advertising techniques have not proven effective at reaching consumers. As a result, consumers may find such businesses less credible then more “established” businesses. Furthermore, there remains an element of paranoia concerning the security of on-line transactions which leads to the reluctance of consumers to participate in e-commerce purchases.

The conventional B&M retail establishment provides at least one feature which is deemed important to most consumers-the ability to touch, examine, and evaluate the merchandise without a commitment to purchase.

In view of the difficulties and drawbacks associated with conventional retailing operations, there is therefore a need for a retailing venue that marries the benefits of conventional retailing with those of e-commerce. There is also a need for a retailing venue that permits examination and evaluation of merchandise without conventional retail overhead. There is also a need for an on-line-based retailing venue with the capability of reaching a large number of potential consumers. There is a also a need for an on-line-based retailing venue that helps consumers overcome initial reluctance to e-commerce. There is also a need for a temporary and mobile retail presence which can be easily relocated to where the greatest potential source of customers are, and/or to simply go into business at any desired time of the year in order to, perhaps, capitalize on the seasonal buying habits of the consumer.

These needs and others are satisfied by the present invention in which a “mobile showroom” with on-site web-based ordering is provided for facilitating a tangible presence for one or more e-commerce-based retail operations.

### SUMMARY OF THE INVENTION

The invention disclosed and claimed herein, in one aspect thereof, is a movable sales showroom system. The system comprises one or more articles of commerce provided for physical presentation to a customer in a first showroom. A customer system is operably positioned in the first showroom for providing information to the customer about the one or more articles of commerce, and for facilitating an e-commerce transaction for the purchase of select ones of the one or more articles of commerce. The customer operates the customer system to obtain information about the select ones of the one or more articles of commerce. The customer also performs the e-commerce transaction utilizing the customer system. The one or more articles of commerce and the customer system are then relocated to a second showroom in response to predetermined criteria.

### BRIEF DESCRIPTION OF THE DRAWINGS

For a more complete understanding of the present invention and the advantages thereof, reference is made to the following description taken in conjunction with the accompanying Drawings, in which:

FIG. 1 illustrates a block diagram indicating the mobile showroom according to the present invention;

FIG. 2 illustrates a flow chart of the process for implementing a disclosed embodiment;

FIG. 3 illustrates a customer terminal/computer station with various input devices;

FIG. 4 illustrates a general block diagram of the network system having Internet and PSTN access;

FIG. 5 illustrates a web page of the user interfaces utilized for performing an on-line transaction; and

FIG. 6 illustrates a database structure which may be implemented according to a disclosed embodiment.

### DETAILED DESCRIPTION OF THE INVENTION

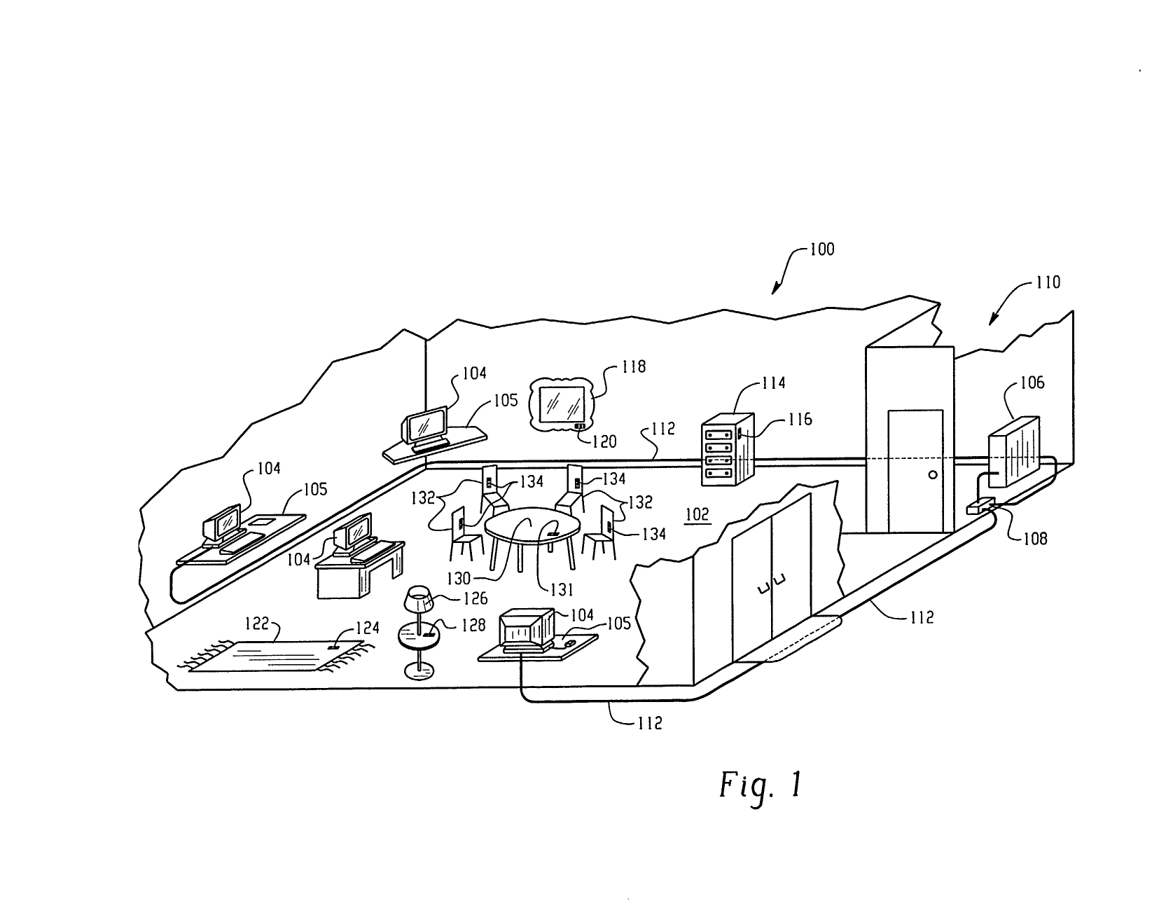

FIG. 1 illustrates one of many different site layouts for a Temporary Internet Mobile Showroom (TIMS) system 100. The “system” 100 is defined generally as comprising merchandise for display, a networked computer/server system used for facilitating customer purchases (and which can connect to the Internet or other global communication network (GCN) to facilitate an e-commerce transaction), and having the attribute that the system 100 is easily relocatable to a different site. The flexibility of the TIMS retail system 100 allows the system 100 to be applied to many different site venues. A showroom 102 is configured to display most, if not all, of the merchandise of the vendor. Note that the disclosed TIMS system 100 is not restricted to buildings, but can also be implemented in vehicles which move from location to location. Additionally, the disclosed system is not restricted to retail transactions, but can be applied to wholesale environments, as well as any transactional environment which involves selling a service or an article of commerce. In this particular embodiment, the merchandise includes household goods, such as furniture, artwork, rugs, etc.

The site 102 is configured with various pieces of merchandise placed around the site location 102 for easy access and inspection by the customer(s). A number of computer terminals (or personal computers) 104 are placed around the site 102 at respective customer stations 105 for access by the customer when he or she prefers to obtain further information about the merchandise or to make a purchase. Each customer station 105 provides various input devices and reference materials for allowing the customer to navigate web pages of information, to input merchandise codes, and to input customer credit information in order to complete the purchase. The customer stations 105 comprising the terminals/computers will be discussed in greater detail hereinbelow, but can be essentially a dumb terminal which simply functions as a device for displaying the user interface such that the user can obtain further product information and/or order the merchandise. Alternatively, the customer terminal/computer 104 can be a personal computer to provide a more robust system for facilitating information retrieval and ordering of merchandise. Notably, the customer stations 105 can also be placed in the center area of the site 102, and not just along the walls, as illustrated. The customer stations 104 are preferably positioned on stands or platforms which are also easily transportable to the next site selected for the TIMS system 100.

The various customer computers 104 are all connected to a local network server 106 via a network hub 108 (or other network device, e.g., a switch, which provides connectivity to the local central server 106. The local server 106 is typically placed in a back office area 110 away from customer access. The customer computers 104 are connected to the local server 106 over a hard wire connection 112. Alternatively, the customer computers 104 may be connected to the local server 106 via a conventional wireless communication architecture (not shown).

The local network server 106 is illustrated as a single box, however, it may comprise a number of servers which facilitate the retrieval of merchandise information from a merchandise database and a purchasing and accounting database for completing a purchasing transaction. The local server 106 also connects to a remote server (not shown) disposed on the Internet (or other GCN). The local server 106 and the remote server communicate such that the local server 106 mirrors the information of the remote server. This function is provided in the case that connection to the Internet is interrupted when customers are in the process of retrieving product information and/or trying to make an on-line purchase. The local server 106 can then accommodate information retrieval of product information from the local database, and the purchase transaction over an alternate connection, e.g., the circuit-switched Public Switched Telephone Network (PSTN) (not shown).

As mentioned hereinabove, the vendor places the merchandise at various locations around the site 102 such that the customer can view, touch, and inspect it before making a decision whether to purchase the product. For example, a dresser 114 has a corresponding identifying code 116 placed thereon. The identifying code could be a conventional UPC bar code which uniquely identifies the dresser 114. The customer, when inspecting the dresser 114, can ask an attendant (not shown) questions about the dresser 114, or where the attendant is unavailable, move to any customer station 105, input the identifying code 116 into the customer computer 104, and retrieve information about the dresser 114. The attendant is also available to assist the customer in operating the customer terminals 104.

One important advantage of the disclosed TIMS system 100 is the capability of introducing customers to the world of on-line purchasing. Many consumers are hesitant, for any number of reasons, to make on-line purchases. One reason may simply be the embarrassment of not knowing how to operate a computer in order to make a purchase, or to retrieve information. The attendant is available to tutor and/or aid the customer in the on-line transaction, such that a subsequent visit to a vendor utilizing the TIMS system 100 would be less arduous. The customer may then order the dresser 114, or continue to looking at other pieces of merchandise at the site 102. The vendor needs to have only one unit of the dresser 114 available for display. This substantial reduction in inventory of the dresser 114, for example, benefits the both the customer and the vendor by reducing the costs associated with requiring the dresser 114 to be kept in inventory, as in convention retail establishments, and lower prices for the customer since inventory costs are no longer a factor figured into the price of the dresser 114. Labor costs are also reduced since no personnel are required to handle the merchandise at the site 102. A picture 118 is displayed on a wall, and also has an unique identifying code 120 associated therewith. In similar fashion, the customer can preview the picture 118, and if deciding to buy it, step to the customer station 105 and enter the identifying code 120 in order to make the purchase. This particular embodiment also includes a rug 122 having its unique code 124, a lamp 126 and its unique code 128, and a table 130 with its unique code 131, and a set of chairs 132 each having a common unique code 134 attached thereto.

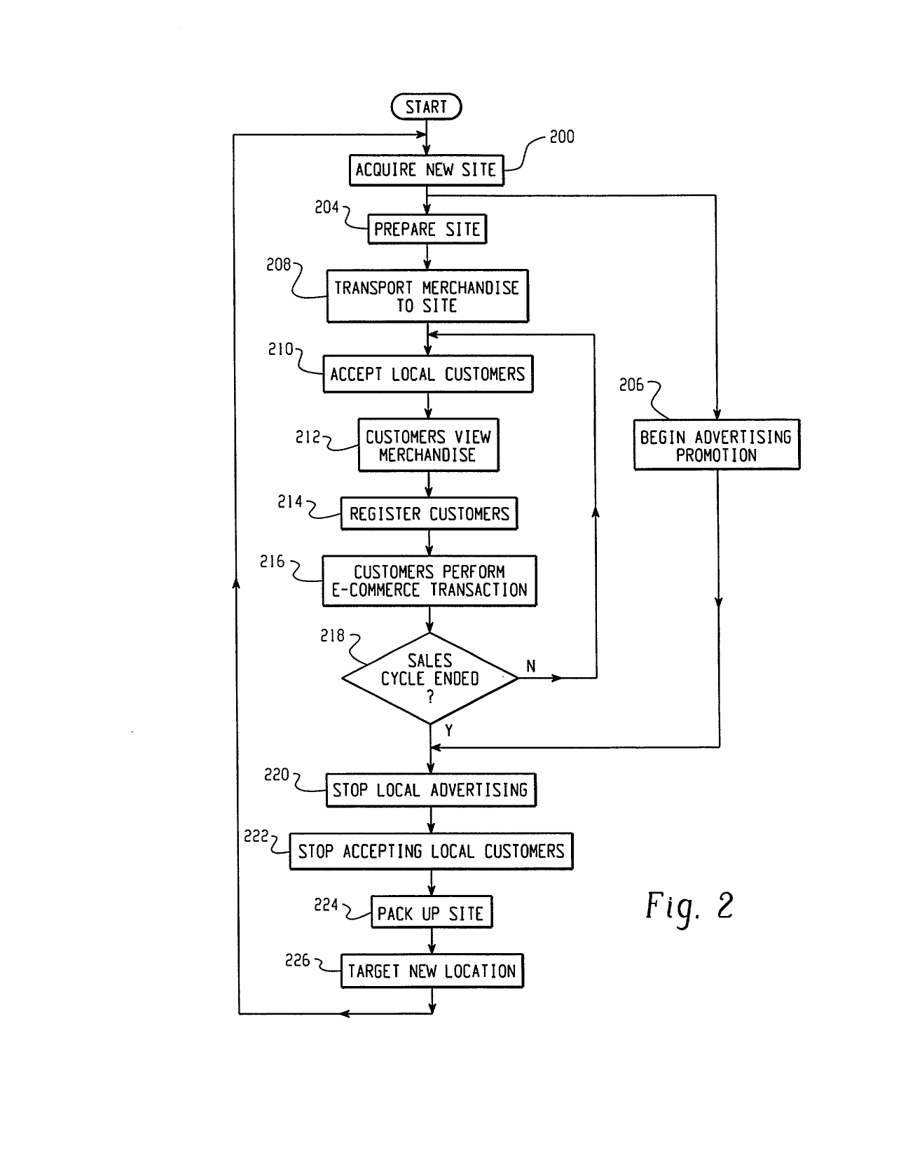

FIG. 2 illustrates a flow chart of the process for implementing a disclosed embodiment of the TIMS system 100. The TIMS approach is basically a two-phase process whereby in Phase A is the “preparatory” phase-the operator acquires a site, starts advertising, prepares the site, and ships the merchandise to the site. Phase B is the “sales” phase which includes “opening the doors” to customers, assisting in customer registration and sales, and closing down in preparation for the next relocation. Flow begins at a Start point and moves to a function block 200 where the vendor acquires a new site 102 for setting up the TIMS system 100 order to sell its products and/or services. The vendor then prepares the site 102 by ensuring proper utility connections, e.g., electricity, telephone access, Internet Service Provider connections, installing the computer system network (hard wire and/or wireless) and making the necessary connections to the remote server disposed on the Internet, as indicated in a function block 204. A wireless data communications connection can be provided via radio, cellular, satellite link, or voice or video connection to the Internet, for accessing the company's web site, or any other suitable connection, varying upon the needs or the infrastructure available at the prepared site 102. Additionally, the TIMS system 100 is amenable to a high-bandwidth system, such as provided by Teligent, Inc., of Vienna, Va., and which allows for real time video and audio connectivity in a bi-directional mode. This provides an additional capability to have direct access to specialists in remote locations. Site acquisition and preparation is preferably accomplished by an advance person or crews associated with the organization implementing the TIMS system 100, although preparation may be contracted through site preparation companies. The preparation phase may also include hiring a small number of staff personnel which will eventually assist customers. At this same time, or perhaps shortly after the vendor acquires the site, the vendor can begin advertising the location and promotions associated with the merchandise, as indicated in a function block 206. This Advertising can be in the form of print and/or broadcast media, direct solicitation by visitation, or other marketing tools, and can be accomplished by either the crew, the staff at the main office, or other staff contracted for this purpose. Flow then moves to a function block 208, where after the site has been prepared, the vendor can then ship the merchandise to the site 102 for set up and display. The merchandise can be used solely for viewing, or can be provided for sale, and includes tables, display cases, and other furnishings needed to provide a temporary showroom presence.

The TIMS system 100 is a complete “physical portal” of a larger organization for displaying merchandise and receiving customers. The TIMS physical portal 100 can be a temporary setup in some established venue, such as a vacant storefront in a strip shopping center or an enclosed mall. The TIMS physical portal 100 can also be a temporary setup in a hotel meeting room, a convention booth, an outdoor tent, or other similar venue. The TIMS system 100 can include merchandise from a single on-line retailer, or a plurality of on-line retailers who have contracted with the TIMS operator.

In addition to the above, the TIMS physical portal 100 may be incorporated in a vehicle or other mobile venue, such as a mall kiosk, or any conventional truck, van, or recreational vehicle adapted for this purpose. A vehicle-based TIMS 100 can be driven and temporarily set up in a parking lot, fairgrounds, or other such open-air venue. Such a vehicle-based TIMS can include a pre-set display area in the interior to permit easy access for prospective consumers, and can include shelving for holding a number of merchandise items which can be examined and evaluated by prospective customers. However, the shelving may optionally be set in the side walls of the TIMS site 102, and exterior panels may be opened to permit open-air access to the merchandise at street level. This would be particularly useful for smaller vehicles. Such a TIMS vehicle could be painted with a company logo or other identifying indicia to permit quick consumer recognition.

Flow is then to a function block 210 where the vendor is ready to open its doors for business and accept customers into the site 102. The customers then shop the site, as indicated in a function block 212, by viewing, touching, and inspecting the merchandise, as desired. Flow continues to a function block 214 where attendants can then register customers who are interested in purchasing products or services, or perhaps to simply be placed on a “mailing list” (e.g., an e-mail list) in order to be kept appraised of upcoming locations having other products of services of interest. If the customer has used the TIMS system 100 before, as affiliated with this particular vendor, he or she may already have personal information stored in a database on the local server 106 (and/or the remote server) which personal information facilitates the purchasing process by retrieving account information. The customer then chooses to purchase a piece of merchandise, and utilizes the customer computer 104 and its associated peripherals to complete the purchase, as indicated in a function block 216. For example, if the customer chooses to purchase the rug 122, he or she records the unique code 124 associated therewith, and enters it into the purchasing system. This code 124 can be enter into the system via a keyboard, or other input device, such as a bar code scanner. Alternatively, the customer could access a catalog of vendor merchandise, which catalog presents a picture of each piece of merchandise at various angles and its respective unique code. The customer can then grasp an indicia reader (e.g., a bar code scanner) and swipe the associated code 124 from the page of the catalog. The customer computer 104 is then operable to use the code 124 in a table look-up operation on a product database which resides on either or both of the local server 106 and the remote server, in order to obtain the price and product information of the rug 122 for display to the customer at the respective customer station 105.

If the customer was a past customer who had already registered with the vendor, he or she could simply be requested to log in to the vendor server in order to expedite the purchasing process by automatically retrieving personal information from the local server 106 (or remote server) related to credit accounts, home address, shipping address, and any other information the vendor chose to store during the registration process, and any other subsequent purchase transaction(s). The login process in this particular embodiment request the customer e-mail address and a password. If the customer did not have an e-mail address, one could be set up at the time of purchase via the customer computer 104 using any of a number of free e-mail companies (e.g., Hotmail™), or the vendor could chose to use other information in lieu of an e-mail address in the login process. The e-mail address is preferable so that the vendor could more directly inform the customer of upcoming vendor sales and promotions. Note that the registration process in function block 214 could be made a requirement before the customer is allowed to view the merchandise in function block 212.

Flow then continues to a decision block 218 where the vendor determines if the sales program has completed. The sales program can be terminated in response to many different criteria, some of which include a change in customer demographics which results in a change of the type of customers which usually frequent the showroom. For example, if the merchandise being offered was expensive furniture which previously was suited for a more affluent customer, and the general type of customer which now frequented the showroom inquired of plastic furniture, which was not carried by the showroom vendor, this shift in demographics would cause a reduction in sales and impact the bottom-line operation of the vendor, and could cause the vendor to close the showroom and move to a different location. Another criteria which would determine if the showroom was to relocate is the seasonal buying habits of customers. For example, the showroom could be configured to be operational only during the Christmas season, or during Valentine's Day, or Thanksgiving, etc. In this scenario, showroom activity is based not only upon the type of season, but also on a fixed duration of time. Since the Christmas season occurs only during a fixed period of time, operation of the showroom occurs until the duration of time for the season lapses. The showroom can then be relocated and reconfigured to sell a different type of merchandise, or perhaps relocated over the course of the holiday season at various locations to sell the same type of merchandise. If not, flow is out the “N” path to the input of function block 210 to continue accepting customers at the site 102. If the sales are tapering off, and the vendor chooses to terminate the sales program, flow is out the “Y” path to a function block 220 to stop local advertising. Notably, the advertising campaign could be continued from shortly after the site was acquired in function block 200 to the point in time when the vendor chooses to end the sales program, at the output of decision block 218. Once the advertising campaign has ceased, flow is to a function block 222 where the vendor stops accepting new customers, as indicated by the vendor “closing the doors” to the site 102. Flow continues to a function block 224 where the vendor and hired personnel tear down and pack up the TIMS system 100 for transport to the next location. This step involves shipping the inventory to storage area, perhaps in the town of the current site 102, or back to a central location of the vendor. The computers and servers can also be shipped with the inventory, as the remote server disposed on the Internet can continue to be accessed by customers, both prior and new, to provide information about products and services, and to facilitate on-line purchases by customers. Flow is then to a function block 226 where the vendor targets a new location. Alternatively, perhaps the vendor is involved in seasonal sales such that the whole operation is shut down until next year. In either case, the vendor will eventually target a site for rent or lease, albeit only temporarily, for the next sales program. After the next location has been targeted, flow loops back to the input of function block 200 to secure the location by whatever means. The process then continues as described hereinabove.

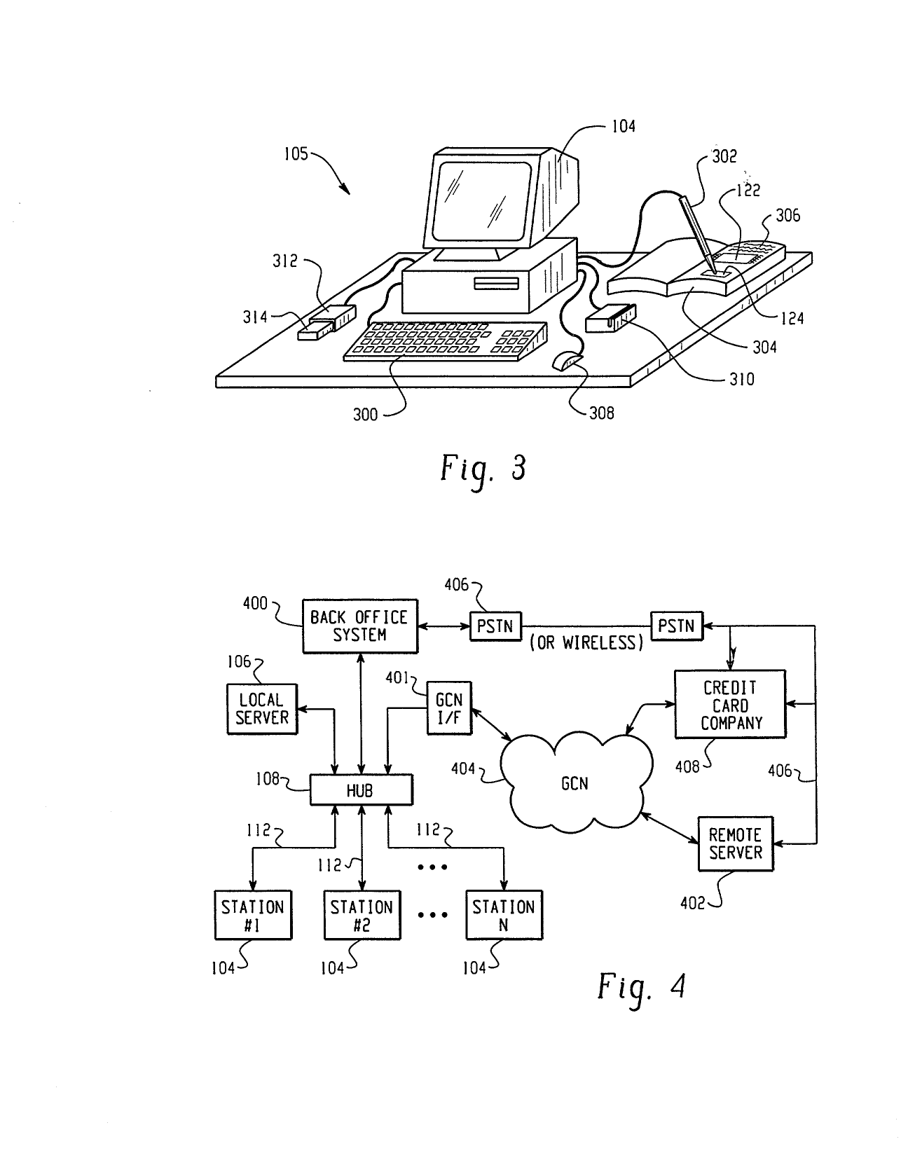

FIG. 3 illustrates a customer terminal/computer station with various input devices. The station 105 comprises the customer computer 104 for accessing the local and/or remote server databases, and displaying information which aids the customer in obtaining further product information and/or purchase one or more products. The unique product code (e.g., code 124 of the rug) can be entered via a number of ways. A keyboard is provided so that the customer (or attendant) can input appropriate responses to database queries and customer information. The merchandise code 124 of the rug can also be keyed in using the keyboard 300, since the code 124 associated therewith is a viewable alphanumeric code. The code 124 can also be scanned using a code scanner 302 (e.g., a bar code scanner). The code scanner 302 attaches to the customer computer 104 and converts readable code indicia 124 into signals which can be interpreted by the customer computer 104 as associated with the rug 122. Alternatively, if the customer failed to record the unique code (or catalog number) of the rug 122, a catalog 304 of all the vendor merchandise is provided at the customer station 105. The catalog 304 presents each piece of vendor merchandise (e.g., the rug 122) in association with its unique code 124, and text information 306 about the rug 122. The customer can then use the scanner 302 to scan the unique rug code 124. The customer computer 104 then retrieves further information about the rug 122 from either server (local 106 or remote) in response to the rug code 124 being scanned, and presents it to the customer at station 105. Alternatively, if the customer wishes to purchase the rug 122, scanning of the unique rug code 124 at the appropriate time, as prompted by the computer 104, will input the unique rug code 124 into the computer order page. The computer 104 then returns price and availability information to the customer. Other information may also be returned and displayed, e.g., quantity on hand, and shipping costs, if the customer had logged in and made available to the database his or her home address so that such shipping costs could be computed based upon the use of common carriers such as United Parcel Post, or the United States Post Office. Alternatively, if the TIMS system 100 was to be in a location for an extended period of time, the purchased merchandise could be shipped to the TIMS location 102 for pickup as a convenience for the customer.

The customer station 105 also includes a mouse input device 308 for convenient input of information and selection of buttons provided on the program pages (e.g., web pages). A card swipe unit 310 is provided such that when the customer chooses to make a purchase, he or she may swipe a credit card in order to pay for the purchase. The corresponding on-line credit authorization company servers may then be accessed to approve the transaction amount for the customer. For example, if a VISA™ credit card was used, a VISA™ web server disposed on the Internet could be immediately accessed to approve the purchase amount. Alternatively, where the customer is less inclined to want to utilize the Internet for the transmission of personal account information, the vendor can configure the site 102 so accept the input of credit information so that it is then transmitted over the secure PSTN to the back-office credit systems of VISA™ in order to make the credit available for the purchase transaction. This avenue of credit approval will be discussed in greater detail hereinbelow.

The customer station 105 can also include a recorder interface unit 312 which is operable to receive a portable scanning unit 314 which the customer can carry around. The portable scanning unit 314 is used to scan the unique codes (e.g., rug code 124) of selected pieces of merchandise as the user shops the vendor site 102. When the user decides to make a purchase, he or she can then bring the portable scanning unit 314 to the recorder unit interface 312, and engage the portable scanning unit 314 into the recorder interface 312. The customer computer 104 is operable to download the stored merchandise codes from the portable scanning unit 314, and enter the stored information into the appropriate program fields, at the proper time.

FIG. 4 illustrates a general block diagram of the network system having Internet and PSTN access. The local server 106 services all of the customer terminals 104 at the respective customer stations 105 (Station #1, Station #2, . . . , Station N). Note that the number of customer terminals 104 provided at the site 102 is based upon the discretion of the vendor who is implementing the TIMS system 100. Each of the customer terminals 104 connects to the hub 108 via the hard wire cable 112. The hub 108 provides central connectivity through a GCN interface device 401 to a GCN 404 (e.g., the Internet) for all of the local networked systems. As noted hereinabove, wireless communications (not shown) may also be utilized between the customer terminals 104 and the hub 108, and/or the hub 108 and any of the local systems. The local server 106 is operably disposed on the GCN 404 by communicating through the GCN interface device 401 (e.g., a router or modem, etc.) to any node on the GCN 404 (e.g., a remote server 402). The local server 106 can connect to the remote server 402 in one of two ways: either via the GCN 404, or through a circuit-switched PSTN system 406 (via a back-office system 400). Although not required for this disclosed embodiment, the back-office server 400 is also provided to process customer account information and transaction processes. Each customer terminal 104 is operable to access a database of the remote server 402 directly by connecting through the GCN interface 401 across the GCN 404 to the remote server 402.

In operation, when the customer logs in to TIMS network or is registered by the attendant, services are made available to the customer from either the local server 106 or the remote server 402, since both servers (106 and 402) can provide the same services. If the GCN 404 link to the remote server 402 is down, the local server 106 is operable to provide all services necessary to the customer through the PSTN network 406. Alternatively, if the PSTN network connection 406 is down, the local server 106 can access all necessary network services of the remote server 402 via the GCN 404. Another alternative is provided where if links to both the PSTN 406 and the GCN 404 are inoperable, the local server 106 can provide the product information and web page experience to the customer. If the customer chooses to use the customer station 105 to obtain further information about a piece of merchandise, he or she can access that information via the customer terminal 104 by entering the product ID, or searching for the product name, which capability will be discussed in greater detail hereinbelow. When the customer chooses to purchase the product or service, a purchasing program provided as a service of the local and/or remote servers (106 and 402, respectively) prompts the customer to enter certain types of personal information. If the customer was a previous purchaser under this vendor's TIMS system 100, or was a registered customer, and a purchase was never made, the databases of the both the local and remote servers (106 and 402) will have stored therein personal information which will be automatically entered into specific fields of the electronic purchasing form for the customer during the purchase transaction. For example, since the customer previously provided a home address during the registration process, this home address would be automatically entered into the shipping address field. Similarly, if the customer had previously provided credit card information, this credit card information would be accessed and automatically cause the back-office server 400 (where the local server 106 is being utilized) to access a credit card web server 408 via either the GCN 404 or the PSTN 406, at the discretion of the customer. Note that where the remote server 402 is being used, the remote server 402 can be made operable to access the corresponding credit card server 408 via either the GCN 404 or the PSTN 406 in order to perform credit verification and authorization of the customer prior to completing the e-commerce transaction.

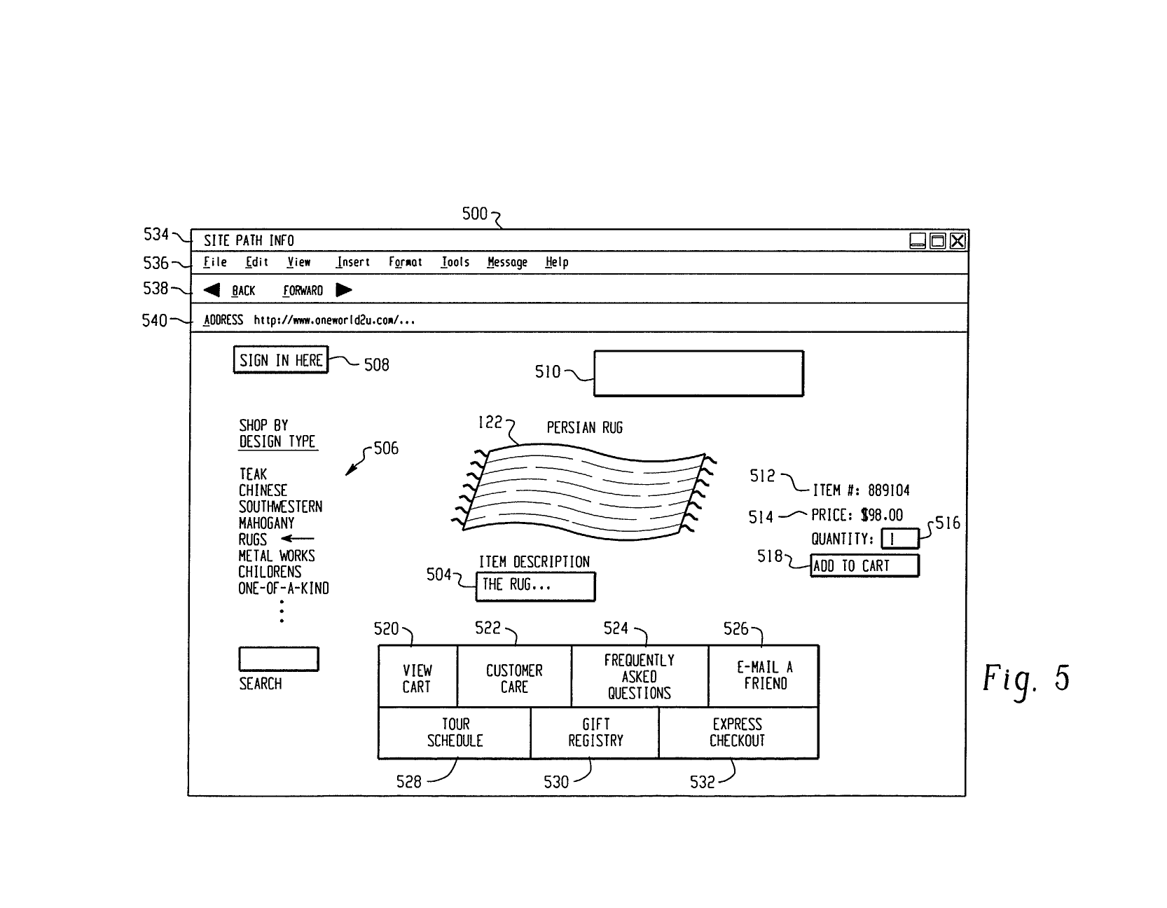

FIG. 5 illustrates a web page 500 of a disclosed embodiment which provides various amounts of information to the customer during the purchase transaction. If the customer were purchasing the rug 122, an image of the rug 122 and associated description information could be searched and retrieved using a search field 502. The search can be performed using the merchandise ID code 124 of the showroom rug 122, the actual name of the rug 122, or other search terms which help the customer to arrive at the particular type of rug 122 he wants to purchase. The description information can be provided in a description field 504 once the item of interest is displayed. A drop-down menuing system 506 provides active links to each product category, and subcategory, which active links return another web page to the customer, similar to the displayed web page 500. The web page also provides a Sign-In link 508 which causes the automatic retrieval of personal information to be used in facilitating the purchasing or product information process. For example, after the customer signs in (or logs in), the database can be accessed to return information related to previous purchases of the vendor. If the customer had previously purchased a chair, the web page may provide a small advertising or promotional area 510 which displays a rug which compliments the previously-purchased chair. Alternatively, the advertisement may offer a reduced sale price for the rug 122 based upon the customer's previous business.

The web page also displays the merchandise item number 512, the item price 514, and a quantity field 516, which the customer can adjust according to the number of items he or she wants to purchase. If the customer choose to purchase the rug 122, he can select an “Add To Cart” button 518 to place the item in reserve until all shopping has been completed. Other options which are provided include a “View Cart” button 520 which allows the customer to view all items currently placed on reserve for possible purchase, a “Customer Care” button 522 which directs the customer to another web page which provides contact information for questions about orders, products, accounts, etc., a “Frequently Asked Questions” button 524 which links to a web page having a list of commonly-asked questions, an “E-mail A Friend” button 526 which provides easy communication to a friend of the vendor products, a “Tour Schedule” button 528 which links to a web page which lists all scheduled stops of the vendor in various geographic locations, a “Gift Registry” button 530 which links to a web page where the customer can set up a Registry of the vendor products for a friend having a birthday, wedding, or other celebration, and an “Express Checkout” button 532 which links the customer to a web page which totals the costs of the products for purchase, computes shipping, inserts the shipping address information in accordance with a registered user, or requests entry of personal credit and account information where the customer has shopped with the vendor for the first time. The web page 500 also provides many conventional features, such as an browser information field 534 which indicates to the user the browser and home page being viewed, a menu area 536 which provides the customer the option to perform other functions, such as to print out information, or to send via e-mail product information to his or her e-mail address, a navigation menu 538 for moving between web pages which were previously accessed, and a URL (Uniform Resource Locator) address field 540 which displays the current network path of the web page.

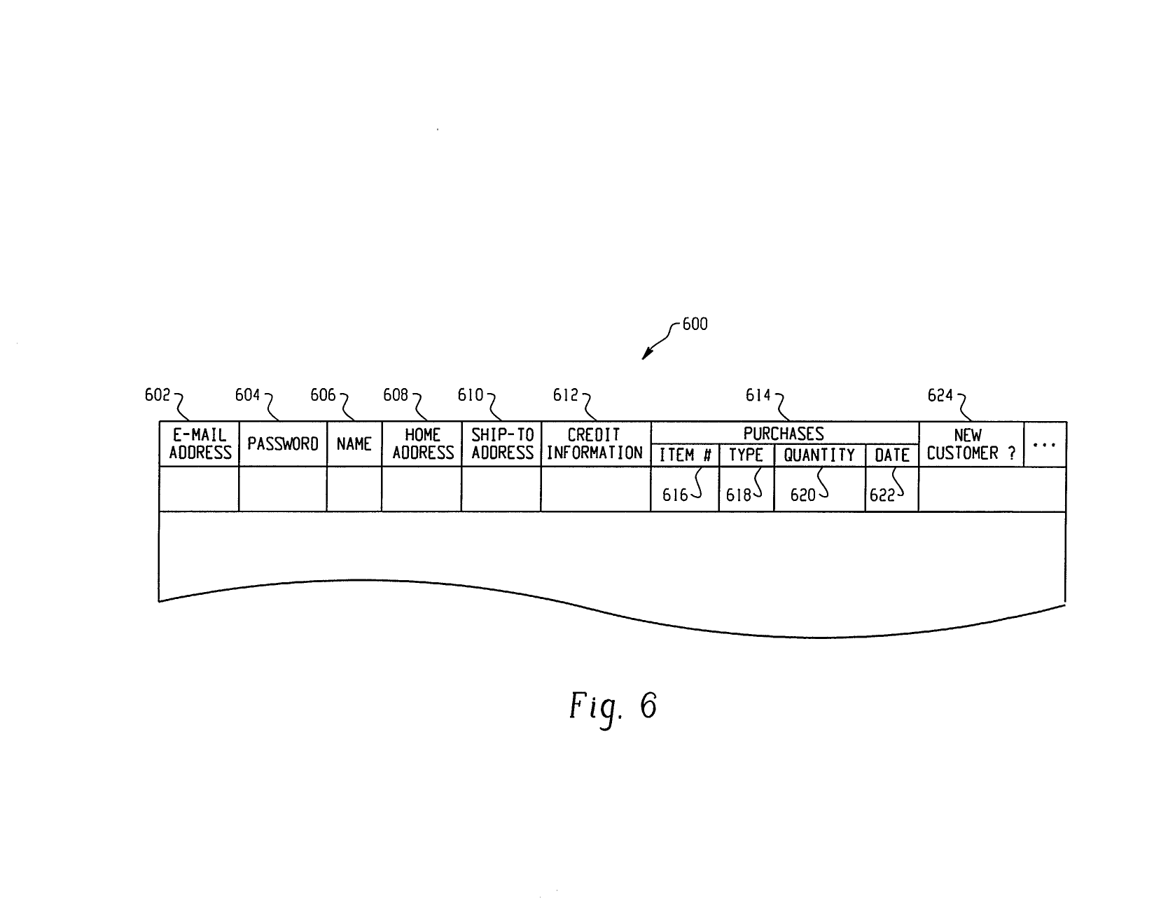

FIG. 6 illustrates a database structure which may be implemented in accordance with a disclosed embodiment. As mentioned hereinabove, the database 600 described herein can be mirrored between the local server 106 and the remote server 402 such that customer data and account information is stored redundantly. The Sign-In process (or login process) mentioned hereinabove comprises entering a password and the customer's e-mail address. Therefore, in order to access the corresponding customer database information in a table lookup format, an e-mail address field 602 and a password field 604 are provided in the database. After verifying the correct password and e-mail address, the corresponding customer data is retrieved from the server (either 106 or 402) for use during the purchase process. For example, the customer's name in a name field 606 can be used on each web page to personally address the customer during use of the TIMS system 100. The customer's home address is stored in a home address field 608, which home address field can be used as a cross check for credit verification. A Ship-To Address data field 610 stores the destination address of a prior e-commerce purchase, and can be automatically inserted into the new Ship-To Address for the customer on the existing purchase. If the customer selects that address for delivery, no corrections need to be made. However, if the delivery address is different, the customer can then edit the delivery address to the proper destination. A Credit Info 612 field stores a credit card number which can be used for the existing purchase. The credit card number is retrieved during the credit verification process of the transaction. A Purchases field 614 stores merchandise information related to past purchases made from this vendor, or of purchases made during the existing transaction. The Purchase field 614 contains sub-fields for the Item #616, the item Type 618 (e.g., rug, table, dresser, etc.), the Quantity (QTY) 620, and the Date 622 the respective item was purchased. Other data may also be used in order to provide programmed responses to the customer during the use of the customer terminal 104. For example, a New Customer field 624 could be used to display a “Welcome” message in response to the customer logging in for the first time. Other fields may also be populated with customer information, and used to enhance the buying experience of the TIMS system 100.

In summary, there is provided mobile showroom system which highly is relocatable and having a substantially reduced inventory of merchandise. The mobile showroom system provides only a minimal inventory of merchandise to show to the customer in the showroom, and provides connectivity to the Internet to facilitate purchasing of the merchandise which can be subsequently delivered from a different location distant from the mobile showroom. Labor and warehouse costs, and leasing costs typically associated with conventional merchandising establishments are substantially reduced when using the disclosed TIMS system in that the several layers of middleman operations are bypassed. All purchases are delivered from a central warehouse, a minimal number of centralized warehouses sited at selected geographic locations, precluding the need to have distributed inventories at many different locations for immediate delivery to customers. The mobile showroom system can then easily pack up and relocate to another area when the vendor chooses to do so. The TIMS system provides the capability of targeting demographics by moving to the location where selected products are sold in greater quantities than other locations. It is no longer necessary to provide a wide variety of merchandise at a fixed location. Additionally, by providing tangible products and a human presence, the TIMS system helps to overcome reluctance on the part of many consumers to participate in the e-commerce boom.

Although the preferred embodiment has been described in detail, it should be understood that various changes, substitutions, and alterations can be made therein without departing from the spirit and scope of the invention as defined by the appended claims.

What is claimed is:

1. A movable sales showroom system, comprising:
one or more articles of commerce provided for physical presentation to a customer in a first showroom; and
a customer system operably positioned in said first showroom for providing information to said customer about said one or more articles of commerce, and for facilitating an e-commerce transaction for purchase of select ones of said one or more articles of commerce;
wherein said customer operates said customer system to obtain information about said select ones of said one or more articles of commerce;
wherein said customer operates said customer system to perform said e-commerce transaction;
wherein said one or more articles of commerce and said customer system are relocated to a second showroom in response to predetermined criteria.

2. The system of claim 1, wherein said customer system is operably disposed on a global communication network, and communicates with a remote transaction server which is operably disposed on said global communication network to provide said information about said select ones of said one or more articles of commerce to said customer in response to a request therefrom, and wherein said remote transaction server processes said e-commerce transaction in response to said customer opting to purchase said select ones of said one or more articles of commerce.

3. The system of claim 1, wherein said one or more articles of commerce provided for physical presentation in said first showroom are not for sale.

4. The system of claim 1, wherein an attendant assists said customer to perform said e-commerce transaction on said customer system.

5. The system of claim 1, wherein said customer system is operably disposed on a global communication network which is a packet-switched network.

6. The system of claim 5, wherein said packet-switched network is the Internet.

7. The system of claim 1, wherein said predetermined criteria includes a change of season.

8. The system of claim 1, wherein said predetermined criteria includes a shift in demographics which causes a reduction in sales of said one or more articles of commerce.

9. The system of claim 1, wherein said predetermined criteria includes a fixed duration of time, and when said fixed duration of time lapses, said first showroom will no longer remain open to said customer.

10. The system of claim 1, wherein said customer purchases select ones of said one or more articles of commerce which are shipped from a location other than the location of said first showroom.

11. A movable sales showroom system, comprising:
one or more articles of commerce for physical presentation to one or more customers in a first showroom; and
one or more customer terminals placed at selected positions in said first showroom for providing information to said one or more customers about said one or more articles of commerce, and for facilitating an e-commerce transaction for purchase of select ones of said one or more articles of commerce;
wherein said one or more customer terminals are operably disposed on a global communication network;
wherein said one or more customers operate one of said one or more customer terminals in order to obtain information about said select ones of said one or more articles of commerce;
wherein said one or more customers operate one of said one or more customer terminals to perform said e-commerce transaction;
wherein said one or more articles of commerce and said one or more customer terminals are relocated to a second showroom in response to predetermined criteria.

12. The system of claim 11, wherein an attendant assists said one or more customers to perform said e-commerce transaction.

13. The system of claim 11, wherein said global communication network is a packet-switched network.

14. The system of claim 13, wherein said packet-switched network is the Internet.

15. The system of claim 11, wherein said predetermined criteria includes a change of season.

16. The system of claim 11, wherein said predetermined criteria includes a shift in demographics which causes a reduction in sales of said one or more articles of commerce.

17. The system of claim 11, wherein said predetermined criteria includes a fixed duration of time, and when said fixed duration of time lapses, said first showroom will no longer remain open to said customer.

18. A method of providing a movable sales system, comprising the steps of:
(a.) configuring a showroom at a temporary location, the step of configuring further comprising the steps of,
(1.) providing one or more articles of commerce for physical presentation in said showroom to a customer; and
(2.) positioning one or more customer systems throughout said showroom for use by said customer to obtain information about select ones of said one or more articles of commerce, and to facilitate the purchase of said select ones of said one or more articles of commerce, said one or more customer systems operably disposed on a global communication network such that said customer can perform an e-commerce transaction over said global communication network in order to purchase said select ones of said one or more articles of commerce;
(b.) providing access to said showroom to said customer for viewing and inspection of said one or more articles of commerce by said customer;
(c.) closing said showroom to said customer in response to predetermined criteria;
(d.) relocating the movable sales system from said temporary location to a different temporary location; and
(e.) repeating steps (a.)-(e.).

19. The method of claim 18, wherein said global communication network in the step of positioning is a packet-switched network.

20. The method of claim 19, wherein said packet-switched network is the Internet.

21. The method of claim 18, wherein said predetermined criteria in the step of closing includes a change of season.

22. The method of claim 18, wherein said predetermined criteria in the step of closing includes a shift in demographics which causes a reduction in sales of said one or more articles of commerce.

23. The method of claim 18, wherein said predetermined criteria in the step of closing includes a fixed duration of time, and when said fixed duration of time lapses, said showroom will no longer remain open to said customer.

24. The method of claim 18, wherein said one or more articles of commerce in said showroom in step (1.) are not for sale.

25. The method of claim 18, wherein said customer purchase select ones of said one or more articles of commerce which are shipped from a central location which is different from than said temporary location.

26. The method of claim 18, wherein said customer, in the step of positioning, enters a respective unique code associated with said select ones of said one or more articles of commerce which are being purchased into one of said one or more customer systems to identify said select ones of said one or more articles of commerce which are to be purchased.
